(19) United States
(12) Patent Application Publication
(10) Pub. No.: US 2001/0055278 A1
(43) Pub. Date: Dec. 27, 2001

(54) Communication control method and apparatus in intelligent network

(76) Inventors: Hiroshi Ooiwane, Fukuoka (JP); Ryuji Fukuhara, Fukuoka (JP)

Correspondence Address: ROSENMAN & COLIN LLP, 575 MADISON AVENUE, NEW YORK, NY, 10022-2585, US

(21) Appl. No.: 09/794,463

(22) Filed: Feb. 27, 2001

(30) Foreign Application Priority Data
Jun. 21, 2000 (JP) 2000-186683

(51) Int. Cl. H04L 12/56

(52) U.S. Cl. 370/237; 370/410

(57) ABSTRACT

Using a transaction established between SSP and SCP or DB for each call, an subnode (DB or SSP) address and transaction identifier are transmitted to the SCP or DB, thereby permitting direct communications between the SSP and DB. This serves to alleviate the processing load of the SCP and reduce traffic in a signaling network when the SCP processes a service request from the SSP in cooperation with the DB.

### BACKGROUND OF THE INVENTION

1. Field of the Invention

The present invention relates to a communication control method and apparatus in a network constructed with a service control node providing intelligent network (IN) services and an arbitrary number of nodes operating in cooperation with the service control node.

2. Description of the Related Art

In software control of electronic switching equipment, recent years have seen major changes from simple end-to-end communication services between circuit switches located at the transport layer to communication services with enhanced capabilities to provide a wide range of advanced services; to enable such communication services, a service control node (service control point—SCP) residing at the intelligent layer includes call control and database search functions necessary for providing the services, and executes and controls requested services, with a circuit switch (service switching point—SSP) at the transport layer operating to connect a call under instruction from the service control node.

Furthermore, with the development of IP (Internet Protocol) networks, for a service control point to cooperate with other networks such as IP networks in controlling service calls, or to provide IN services in a network configuration interconnected with the intelligent layers of other communication providers, there has arisen the need to perform communications with a plurality of nodes, including SSPs at the transport layer and service control nodes at the intelligent layer, operating in cooperation with one another.

Each node communicating with the service control node exchanges messages on a signaling network through an interface defined by the Transaction Capabilities Application Part (TCAP) protocol (ITU-T recommendations Q.77x series). Since TCAP is terminated in each node, if the message is to be transmitted over a plurality of arbitrary nodes, an application in the relay (intermediate) node must transfer the message.

Consider the case where, based on a service request detected at an SSP (source node), a message is relayed via an SSP or a service control node (relay node) to another service control node (cooperating node).

Examples of relaying a message with a service control node acting as the relay node include, for example, the case where, when there is a service control node (DB node) connected via an IP network to a service-providing user and capable of permitting the user to directly reconfigure the contents of registration information, a service control node that accepted a service request from a subscriber issues a request to such a service control node for processing.

Examples in which an SSP acts as the relay node include, for example, the case where, when a service request accepted at a certain SSP is a request for a service that a service control node in another communication provider using a different service language is able to provide, the message is transferred to another SSP having the capability to translate the service language, this other SSP thus acting as the relay node.

In either case, of the messages from the source node or the cooperating node, the message relating to call control needs to be transferred to the relay node, but all the messages need not necessarily be transferred via the relay node. Nevertheless, in the prior art, all the messages have had to be transferred via the relay node if the messages are to be delivered to the cooperating node or the source node, and this has resulted in the problem that unnecessary processing delays occur and the processing load on the relay node unnecessarily increases.

Furthermore, at a signaling station connecting the relay node to the signaling network, since the messages from the cooperating node are transferred to the relay node and the messages from the relay node are transferred to the source node, the amount of signal transfer increases, causing the problem of congestion.

If congestion occurs at this signaling station, since the messages transmitted from the cooperating node cannot be transferred to the relay node, transactions between the source node and the relay node are temporarily suspended. If this happens, at the source node the call that encountered the congestion cannot be released until the abort timer expires, and this leads to the problem of delayed reaction to the end user.

### SUMMARY OF THE INVENTION

Accordingly, it is an object of the present invention to provide a configuration in which, when a first transaction is established between a first node and a second node and a second transaction between the second node and a third node in a signaling network, data that need not be transferred via the second node can be transferred from the third node to the first node without passing through the second node.

An attendant object of the present invention is to make provisions so that the resource for the transaction at the first node can be released immediately when the third node is notified of the occurrence of congestion at a signaling station connecting the second node to the signaling network.

To achieve the above objects, in an intelligent network in which a first transaction is assigned between a first node and a second node and a second transaction between the second node and a third node in response to a service request from a subscriber, a message containing an identifier of the first node and an identifier of the first transaction is transmitted from the second node to the third node over the second transaction, and the identifier of the first node and the identifier of the first transaction transmitted from the second node are stored at the third node, thereby making it possible to transmit a message from the third node to the first node without passing through the second node.

For example, the first node is a service switching node which, in response to a request from a subscriber, requests a service control node for service processing, the second node is the service control node, and the third node is a cooperating node which accomplishes the service processing in cooperation with the service control node in response to a request from the service control node.

In this case, the cooperating node can transmit data to the service switching node without the intervention of the service control node and, in the event of congestion, a resource release message can be transmitted from the cooperating node directly to the service switching node.

In an alternative configuration, the first node is a cooperating node which accomplishes service processing in cooperation with a service control node in response to a request from the service control node, the second node is the service control node, and the third node is a service switching node which, in response to a service request from a subscriber, requests the service control node for service processing.

In this case, the service switching node can transmit a message requesting data directly to the cooperating node, and an instruction specifying whether the data is to be transmitted directly or via the service control node, depending on the nature of the data, can be included in the message.

### BRIEF DESCRIPTION OF THE DRAWINGS

FIG. 1 is a diagram showing the configuration of a system according to one embodiment of the present invention;

FIG. 2 is a block diagram showing the configuration of each node;

FIG. 3 is a diagram showing TCAP protocol management information at a source node (SSP);

FIG. 4 is a diagram showing TCAP protocol management information at a relay node (SCP);

FIG. 5 is a diagram showing TCAP protocol management information at a cooperating node (DB);

FIG. 6 is a diagram showing how the TCAP protocol management information at the cooperating node (DB) is changed;

FIG. 7 is a sequence diagram according to the first embodiment of the present invention;

FIG. 8 is a diagram showing the protocol stacks of signals shown in FIG. 7;

FIG. 9 is a diagram showing the protocol stacks of signals shown in FIG. 7;

FIG. 10 is a diagram showing the protocol stacks of signals shown in FIG. 7;

FIG. 11 is a sequence diagram illustrating a second embodiment of the present invention; and

FIG. 12 is a sequence diagram illustrating a third embodiment of the present invention.

### DESCRIPTION OF THE PREFERRED EMBODIMENTS

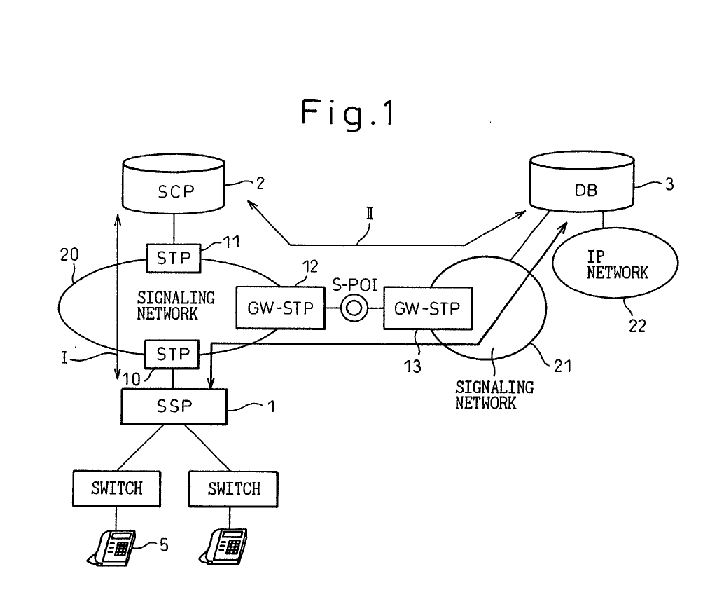

FIG. 1 is a diagram showing the configuration of a system according to one embodiment of the present invention. The embodiment of the invention described herein will deal with an example in which the relay node is a service control point (SCP), but it will be appreciated that the present invention is also applicable to the case where the relay node is a service switching node, as previously described.

Node 1 is a service switching point (hereinafter abbreviated SSP) responsible for call switching. Node 2 is a service control point (hereinafter abbreviated SCP) responsible for service control and, in the example described below, acts as a relay node. Node 3 is a database server (hereinafter abbreviated DB) which operates in cooperation with the SCP, is connected to a user via an IP network 22, and manages user registration data.

Here, the SSP is acting as the source node, the SCP as the relay node, and the DB as the cooperating node. The SSP and the SCP are located in the same signaling network 20, while the DB which operates in cooperation with the SCP is located in another signaling network 21 connected to the network 20 via signaling stations 12 and 13.

Signaling station 10 is a signal transfer point for transferring signaling messages between the SSP and the common channel signaling network 20. Signaling station 11 is a signal transfer point for transferring signaling messages between the SCP and the common channel signaling network 20. The signaling stations 12 and 13 are signal transfer points for transferring signaling messages between the signaling networks 20 and 21.

The following description is given by dealing with an example in which an interface defined by the Transaction Capabilities Application Part (TCAP) protocol (ITU-T recommendations Q.77x series) is used as an internode interface.

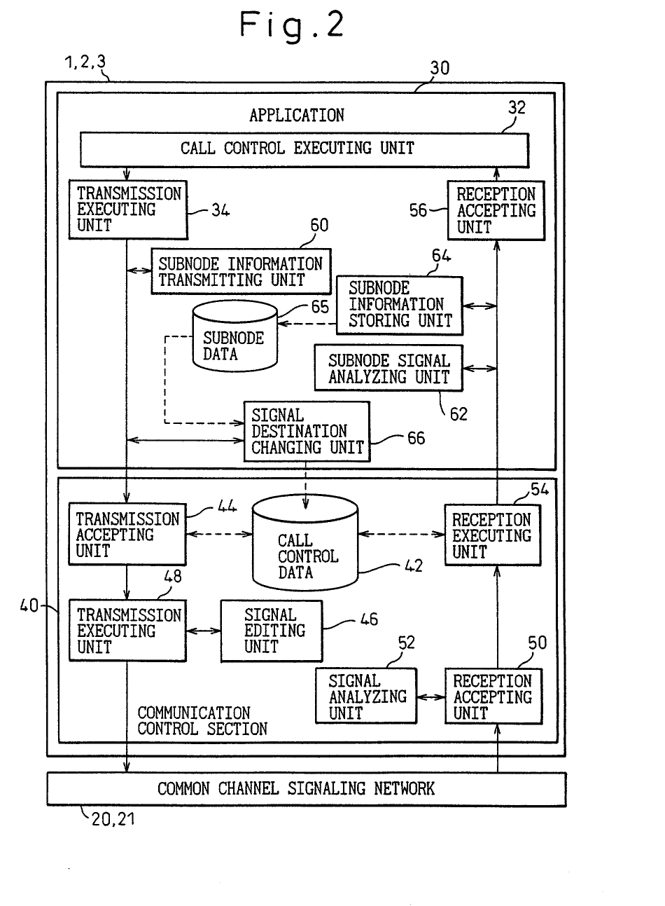

FIG. 2 is a block diagram showing the configuration of each of the nodes 1 to 3.

As shown in FIG. 2, each of the nodes 1 to 3 includes, as an application function 30, a call control executing unit 32 and a transmission executing unit 34 for transmitting call control information and, as a communication control function 40, a transmission accepting unit 44 for accepting a transmit request from the application 30 and for deriving from call control data 42 the destination node information necessary for communication, a signal editing unit 46 for assembling a message, and a transmission executing unit 48 for transmitting the message. Each node thus transmits the call control information to another node. Each of the nodes 1 to 3 further includes, as the communication control function 40, a reception accepting unit 50 for accepting a message-received notification via the common channel signaling network 20 or 21, a signal analyzing unit 52 for analyzing the received message, and a reception executing unit 54 for setting in the call control data 42 the destination node information necessary for communication, and for reporting the call control information to the application 30 and, as the application function 30, a reception accepting unit 56 for accepting the information reported from the communication control section 40 and a call control executing unit 32 for executing call control based on the reported call control information. Each node thus receives the call control information from another node. IN service calls are controlled throughout the network having such nodes.

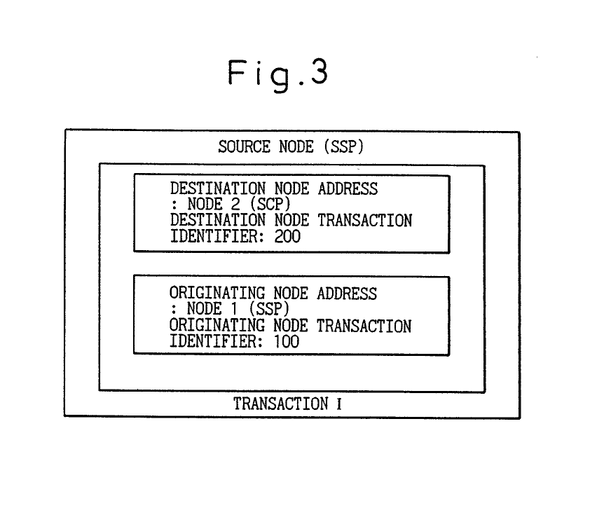

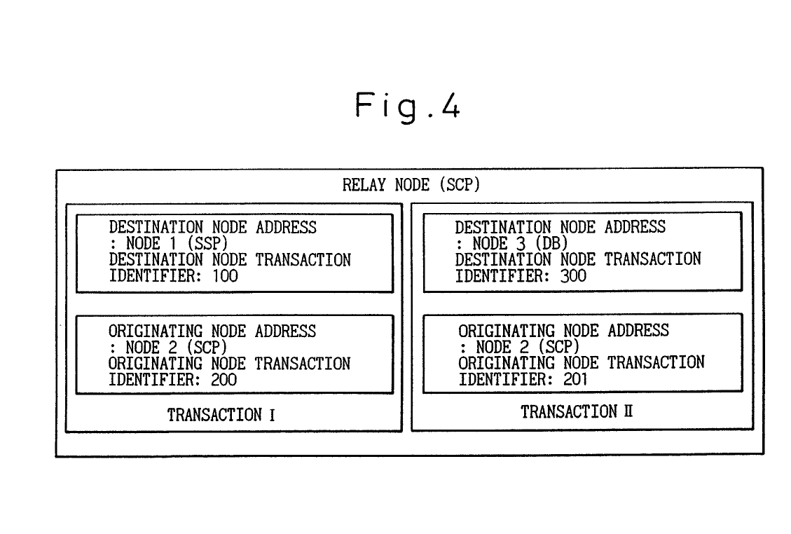

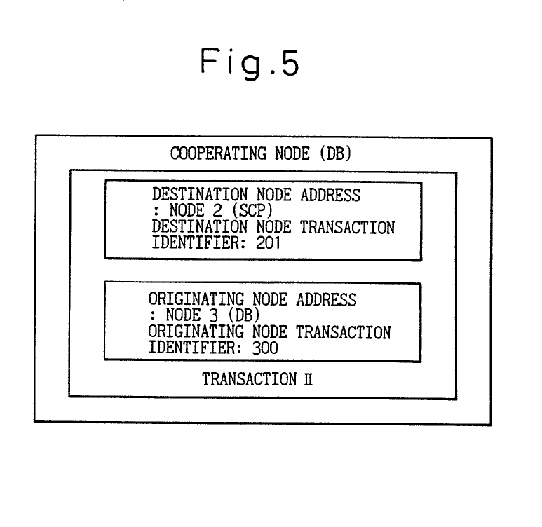

When there is a service request from a subscriber terminal 5 in FIG. 1, a transaction I is established between the SSP (node 1) and the SCP (node 2) and a transaction II between the SCP and the DB (node 3), as will be described in detail later, by using the above-described functions. At this time, as shown in FIG. 3, at the SSP (node 1) as the source node, the node address of the “node 2” as the destination node of the transaction I and “200” as a transaction identifier at the destination node for the transaction I are stored in the call control data 42, together with the node address of the originating node and “100” as a transaction identifier at the originating node for the transaction I. Likewise, information such as that shown in FIG. 4 is stored in the call control data 42 at the SCP (node 2) as the relay node, and information such as shown in FIG. 5 is stored in the call control data 42 at the DP (node 3) as the cooperating node.

The above-described functions are the same as those incorporated in each node in conventional INs, but the present invention differs from the conventional configuration by the inclusion of a subnode information transmitting unit 60, a subnode signal analyzing unit 62, a subnode information storing unit 64, and a signal destination changing unit 66, as shown in FIG. 2.

The subnode information transmitting unit 60 sets call identifying information and node identifying information unique to the remote terminating node as subnode information in user message information, and requests the communication control section 40 to transmit out the information. More specifically, in the relay node, the subnode information transmitting unit 60 requests the communication control section 40 to transmit the destination node address “node 1” of the transaction I and the destination node transaction identifier “100” shown in FIG. 4 as the subnode information to the cooperating node over the transaction II.

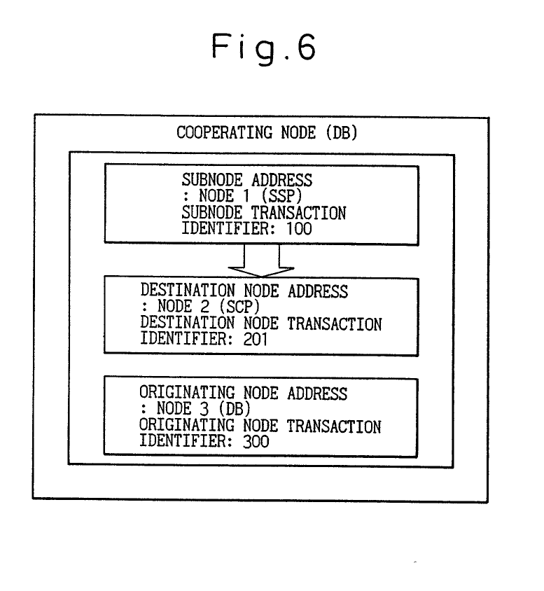

The subnode signal analyzing unit 62 analyzes the subnode information contained in the user message information received from another node. The subnode information storing unit 64 stores the node identifying information and call identifying information extracted by the subnode signal analyzing unit 62 as subnode data 65 if it is necessary to store these pieces of information. When transmitting a message, the signal destination changing unit 66 changes the destination node information by using the subnode information extracted by the subnode signal analyzing unit 62 or stored by the subnode information storing unit 64. More specifically, in the cooperating node, the signal destination changing unit 66 changes the destination node address and the value of the destination node transaction identifier as shown in FIG. 6, by using the subnode information received from the relay node. As a result, data from the cooperating node (DB) is transmitted directly to the source node (SSP) without passing through the relay node (SCP).

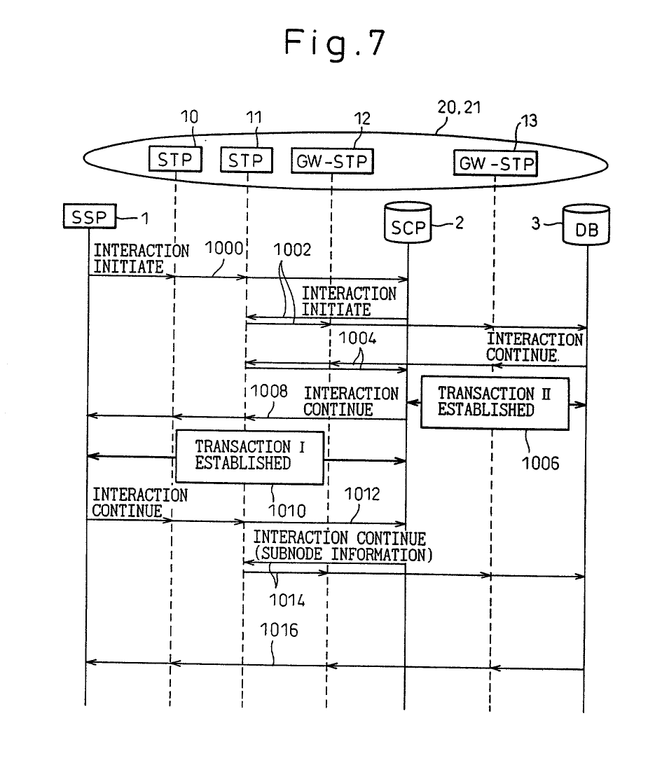

The above process will be described in further detail with reference to the sequence diagram of FIG. 7.

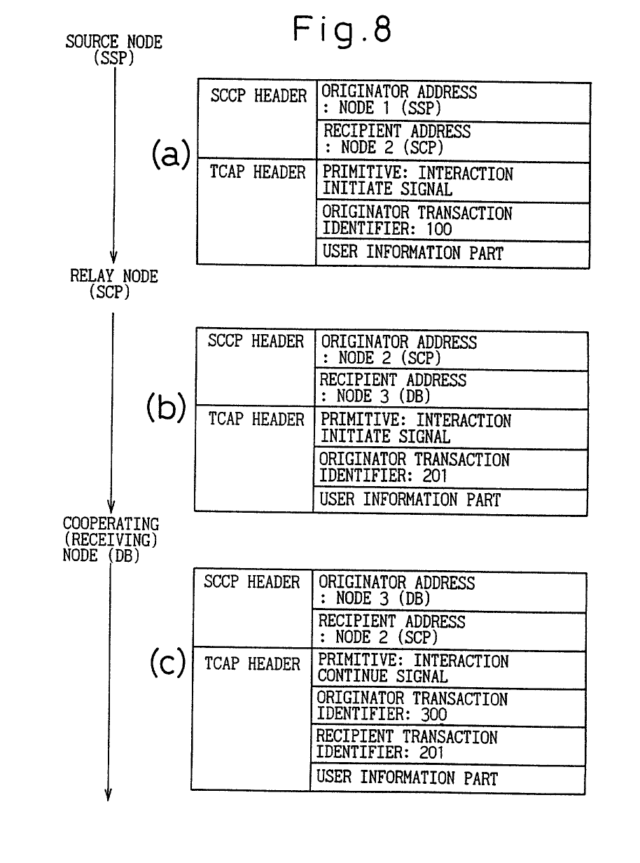

When a call requiring service control by the SCP (node 2) is received at the SSP (node 1), the call control executing unit 32 in the application section 30 (FIG. 2) activates the transmission accepting unit 44 in the communication control section 40 by using the transmission executing unit 34. In the communication control section 40, the transaction identifier “100” for identifying the call is assigned by the transmission accepting unit 44, and the SSP address information “node 1” and the call identifying transaction identifier “100” are set as the originating node information and held in the call control data 42 deployed in the communication control section 40 of the SSP (FIG. 3). Next, the transmission executing unit 48 generates an “interaction initiate signal” as a trigger signal for initiating the call by setting the transaction identifier “100” as the originator transaction identifier and the SSP address information “node 1” as the originator address, as information elements in the transmission message by using the signal editing unit 46, and transmits the thus generated signal to the SCP (step 1000 in FIG. 7). The protocol stack of this signal is shown in part (a) of FIG. 8.

In the SCP, the “interaction initiate signal” from the SSP is received at the reception accepting unit 50 in the communication control section 40, the transaction identifier “200” for identifying the call is assigned, and the signal is analyzed by the signal analyzing unit 52 for verification. At the same time, the transaction identifier and address information are extracted as the destination node information and, in the reception executing unit 54, the SSP address information “node 1” and call identifying transaction identifier “100” as the destination node information, and the SCP address information “node 2” and transaction identifier “200” as the originating node information, are set and held in the call control data 42 deployed in the communication control section 40 of the SCP (FIG. 4), and reported to the reception accepting unit 56 in the application section 30.

In the application section 30, when it is decided that the service call should be controlled in cooperation with the DB (node 3), the call control executing unit 32 activates the transmission accepting unit 44 in the communication control section 40 by using the transmission executing unit 34. At this time, the transaction identifier “201” for identifying the call is assigned in the transmission accepting unit 44, and the SCP address information “node 2” and the call identifying transaction identifier “201” are set as the originating node information and held in the call control data 42 deployed in the communication control section 40 of the SCP (FIG. 4). Next, the transmission executing unit 48 generates an “interaction initiate signal” by setting the transaction identifier “201” as the originator transaction identifier and the SCP address information “node 2” as the originator address, as information elements in the transmission message by using the signal editing unit 46, and transmits the thus generated signal to the DB (step 1002 in FIG. 7). The protocol stack of this signal is shown in part (b) of FIG. 8.

In the DB, the “interaction initiate signal” from the SCP is received at the reception accepting unit 50 in the communication control section 40, the transaction identifier “300” for identifying the call is assigned, and the signal is analyzed by the signal analyzing unit 52 for verification. At the same time, the transaction identifier and address information are extracted as the destination node information and, in the reception executing unit 54, the SCP address information “node 2” and call identifying transaction identifier “201” as the destination node information, and the DB address information “node 3” and call identifying transaction identifier “300” as the originating node information, are set and held in the call control data 42 deployed in the communication control section 40 of the DB (FIG. 5), and reported to the reception accepting unit 56 in the application section 30.

To return a positive acknowledgement to the SCP to acknowledge correct receipt of the “interaction initiate signal”, the call control executing unit 32 in the application section 30 activates the communication control section 40 by using the transmission executing unit 34. In the communication control section 40, the transmission accepting unit 44 derives the originating node information and destination node information. Next, the transmission executing unit 48 generates an “interaction continue signal” by setting the transaction identifier “300” as the originator transaction identifier, the DB address information “node 3” as the originator address, the destination node information, i.e., the transaction identifier “201” as the recipient transaction identifier, and the SCP address information “node 2” as the recipient address, as information elements in the transmission message by using the signal editing unit 46, and transmits the thus generated signal to the SCP (step 1004 in FIG. 7). The protocol stack of this signal is shown in part (c) of FIG. 8.

In the SCP, the “interaction continue signal” from the DB is received at the reception accepting unit 50 in the communication control section 40, and the signal is analyzed by the signal analyzing unit 52 for verification. At the same time, the transaction identifiers and address information in the originating node information and destination information are extracted and, in the reception executing unit 54, the call corresponding to the transaction identifier “201” in the originating node information is identified and the transaction identifier “300” and address information “node 3” as the destination node information are set and held in the call control data 42 deployed in the communication control section 40 of the SCP (FIG. 4), and reported to the reception accepting unit 56 in the application section 30.

Thereafter, the SCP-DB communication at the TCAP level initiated by the current call is associated with the transaction identifier 201 of the SCP and the transaction identifier 300 of the DB, and the transaction II is thus established (step 1006 in FIG. 7).

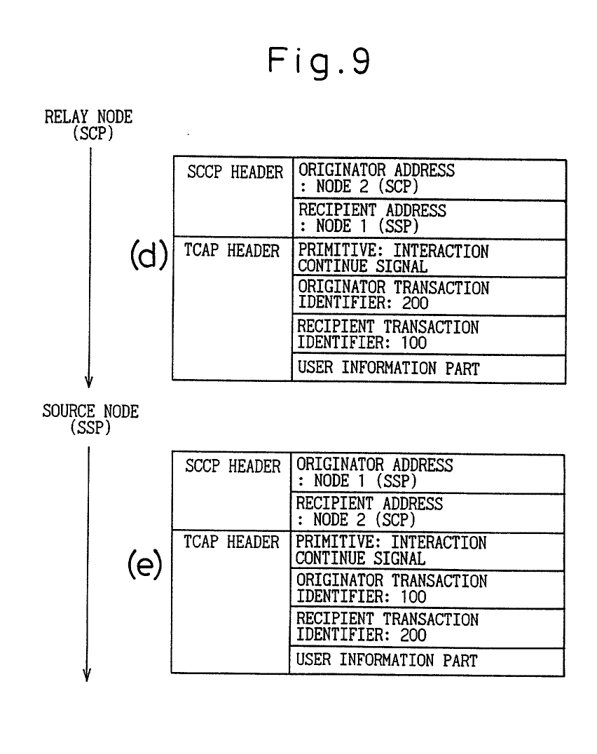

To return a positive acknowledgement to the SSP to acknowledge correct receipt of the “interaction initiate signal”, the call control executing unit 32 in the application section 30 activates the communication control section 40 by using the transmission executing unit 34. In the communication control section 40, the transmission accepting unit 44 derives the originating node information and destination node information, and the transmission executing unit 48 transmits to the SSP an “interaction continue signal” generated by setting the originating node information, i.e., the transaction identifier “200” as the originator transaction identifier and the SCP address information “node 2” as the originator address, and the destination node information, i.e., the transaction identifier “100” as the recipient transaction identifier and the SSP address information “node 1” as the recipient address, as information elements in the transmission message by using the signal editing unit 46 (step 1008 in FIG. 7). The protocol stack of this signal is shown in part (d) of FIG. 9.

In the SSP, the “interaction continue signal” from the SCP is received at the reception accepting unit 50 in the communication control section 40, and the signal is analyzed by the signal analyzing unit 52 for verification. At the same time, the transaction identifiers and address information in the originating node information and destination information are extracted and, in the reception executing unit 54, the call corresponding to the transaction identifier “100” in the originating node information is identified and the transaction identifier “200” and address information “node 2” as the destination node information are set and held in the call control data 42 deployed in the communication control section 40 of the SSP (FIG. 3), and reported to the reception accepting unit 56 in the application section 30.

Thereafter, the SSP-SCP communication at the TCAP level initiated by the current call is associated with the transaction identifier 100 of the SSP and the transaction identifier 200 of the SCP, and the transaction I is thus established (step 1010 in FIG. 7).

FIG. 3 shows the TCAP protocol management information at the SSP when the transaction is established between the respective nodes, FIG. 4 shows the TCAP protocol management information at the SCP, and FIG. 5 shows the TCAP protocol management information at the DB. In this way, the SSP is able to know the node information of the SCP, which in turn is able to know the node information of the SSP and DB, and the DB is able to know the node information of the SCP.

After that, to continue the call, the SSP transmits an “interaction continue signal” to the SCP by using the call control executing unit 32 and the transmission executing unit 34 in the application section and the transmission accepting unit 44 and the signal editing unit 46 in the communication control section 40 (step 1012 in FIG. 7). The protocol stack of this signal is shown in part (e) of FIG. 9.

In the SCP, the “interaction continue signal” from the SSP is received at the reception accepting unit 50 in the communication control section 40, and the signal is analyzed by the signal analyzing unit 52 for verification. At the same time, the transaction identifiers and address information in the originating node information and destination information are extracted and, in the reception executing unit 54, the call corresponding to the transaction identifier 200 in the originating node information is identified, and reported to the reception accepting unit 56 in the application section 30.

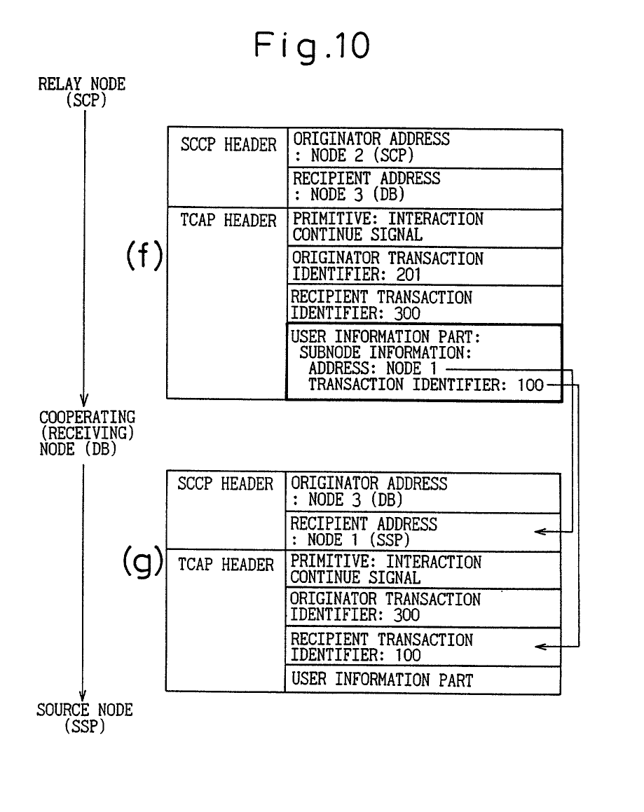

According to the present invention, to enable the return path of the “interaction continue signal” from the DB to be changed to the SSP, the call control executing unit 32 in the application section 30 extracts the node information of the SSP from the information of the transaction I established through the communication with the SSP. The transmission executing unit 34 sets the extracted transaction identifier “100” and address information “node 1” as subnode information in the user message information by using the subnode information transmitting unit 60, and activates the transmission accepting unit 44 in the communication control section 40. In the communication control section 40, the transmission accepting unit 44 extracts the originating node information and destination information, and the transmission executing unit 48 generates an “interaction continue signal” by setting the transaction identifier “200” as the originator transaction identifier, the SCP address information “node 2” as the originator address, the destination node information, i.e., the transaction identifier “300” as the recipient transaction identifier, and the DB address information “node 3” as the recipient address, as information elements in the transmission message by using the signal editing unit 46, and transmits the thus generated signal to the DB (step 1014 in FIG. 7). The protocol stack of this signal is shown in part (f) of FIG. 10.

In the communication control section 40 of the DB, after the signal reception processing in the reception accepting unit 50, signal analyzing unit 52, and reception executing unit 54 is completed, the received signal is reported to the reception accepting unit 56 in the application section 30. The reception accepting unit 56 extracts the SSP address information “node 1” and transaction identifier “100” from the subnode information in the user message information by using the subnode signal analyzing unit 62, and the subnode information storing unit 64 stores the extracted subnode information in the subnode data 65 deployed in the application section 30 of the DB.

After that, the call control executing unit 32 and transmission executing unit 34 are activated and, to change the destination node to the SSP, the node information held in the call control data 42 in the communication control section 40 of the DB is changed by the signal destination changing unit 66 to match the SSP address information “node 1” and transaction identifier “100” stored by the subnode information storing unit 64; then, the transmission accepting unit 44 in the communication section 40 is activated. In the communication control section 40, the transmission accepting unit 44 extracts the originating node information and destination node information. Next, the transmission executing unit 48 generates an “interaction continue signal” by setting the transaction identifier “300” as the originator transaction identifier, the DB address information “node 3” as the originator address, the destination node information, i.e., the transaction identifier “100” as the recipient transaction identifier, and the SSP address information “node 1” as the recipient address, as information elements in the transmission message by using the signal editing unit 46, and transmits the thus generated signal directly to the SSP without passing through the SCP (step 1016 in FIG. 7). The protocol stack of this signal is shown in part (g) of FIG. 10. The TCAP protocol management information at the DB is shown in FIG. 6.

As described above, means for transmitting the node information unique to the terminating node as the subnode information is provided at the signal transmitting end, while means for extracting, analyzing, and storing the subnode information and means for changing the destination to that indicated by the information contained in the subnode information are provided at the signal receiving end. This configuration enables the DB and SSP to transfer signals directly between them via the signaling stations 13, 12, and 10 without the intervention of the relay node.

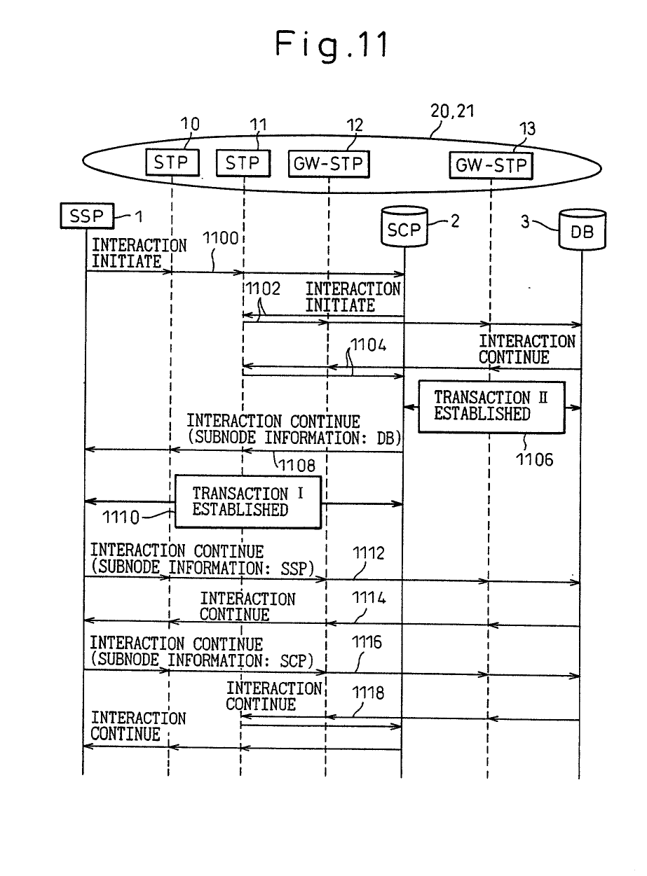

Next, a second embodiment of the present invention will be described with reference to FIG. 11. The procedure for transmitting the “interaction initiate signal” from the SSP to the SCP (step 1100), the procedure for transmitting the “interaction initiate signal” from the SCP to the DB (step 1102), and the procedure for transmitting the “interaction continue signal” from the DB to the SCP (step 1104) are the same as those in the previously described steps 1000, 1102, and 1104, respectively. The operation of each unit shown in FIG. 2 is also the same, and will not be described herein.

The SCP receives the “interaction continue signal” from the DB and, for the return path of the “interaction continue signal” from the SSP to be changed to the DB, the DB node information is extracted from the information of the transaction II established through the communication with the DB, and the “interaction continue signal” carrying this node information as the subnode information in the user message information is transmitted to the SSP (step 1108).

The SSP extracts the DB address information and transaction identifier from the subnode information in the user message information and, to change the destination node to the DB, changes the node information in the call control data to match the extracted DB address information and transaction identifier. Further, the destination of the acknowledgement signal to be returned in response to the “interaction continue signal” transmitted from the SSP is set in the subnode information. For example, when it is desired to have the acknowledgement signal returned directly to the originating node, i.e., the SSP, the transaction identifier “100” and address information “node 1” are set as the subnode information in the user message information; on the other hand, when it is desired to have the acknowledgement signal returned by way of the relay node, i.e., the SCP, the transaction identifier “201” and address information “node 2” are set as the subnode information in the user message information. Here, the “interaction continue signal” is transmitted directly to the DB without passing through the SCP (step 1112 or 1116).

In the DB, the subnode information contained in the user message information is extracted and, to change the destination node to the SSP or SCP in accordance with the extracted information, the node information held in the call control data is changed to match the extracted SSP address information and transaction identifier or the extracted SCP address information and transaction identifier.

As described above, the SSP judges the condition whether or not the acknowledgement signal from the DB requires call control at the SCP, and transmits the message to the DB by adding the corresponding subnode information. The DB returns the acknowledgement signal along the return path specified in the subnode information received from the SSP. In this way, dynamic call control can be performed in cooperation with a node arbitrarily determined by the originating SSP.

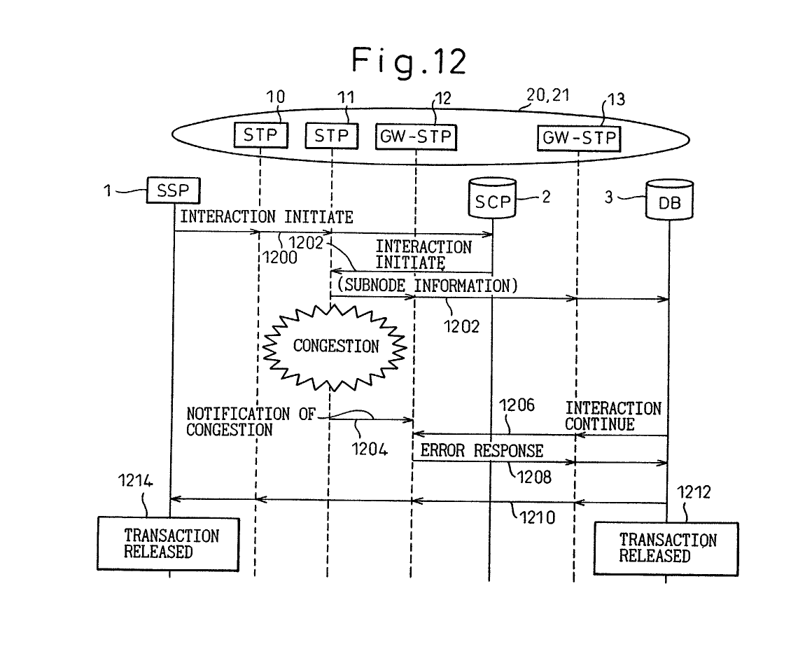

Next, a third embodiment of the present invention will be described with reference to FIG. 12. The procedure for transmitting the “interaction initiate signal” from the SSP to the SCP (step 1200) is the same as that described in step 1000 in FIG. 7. The operation of each unit shown in FIG. 2 is also the same, and will not be described herein.

To enable the return path of the “interaction continue signal” from the DB to be changed to a desired node, the SCP extracts the SSP node information from the information of the interaction I established through the communication with the SSP, and transmits the “interaction initiate signal” to the DB by setting this node information as the subnode information in the user message information (step 1202).

In the DB, the subnode information in the user message information is extracted and stored.

After that, the “interaction continue signal” is transmitted to the SCP (step 1206). However, if congestion occurs at the signaling station 11 in the signaling network adjacent to the SCP (step 1204), the “interaction continue signal” cannot be transferred to the SCP, and an error condition is returned to the DB (step 1208). In the DB, as an error reaction the node information held in the call control data is changed to match the earlier stored SSP address information in order to change the destination node to the SSP, whereupon an “interaction aborted signal” is transmitted directly to the SSP without passing through the SCP (step 1210), and in the DB, the transaction identifier 300 as the transaction resource assigned in relation to the SCP is released (step 1212).

In the SSP also, the transaction identifier 100 as the transaction resource assigned in relation to the SCP is released upon receiving the “interaction aborted signal” (step 1214).

In the SCP, it being unable to receive an acknowledgement signal from the SSP or the DB, the application timer expires, whereupon the transaction identifier 200 as the transaction resource assigned in relation to the SSP and the transaction identifier 201 as the transaction resource assigned in relation to the DB are released.

When an error response is returned as the result of a transmission to the SCP for some reason (congestion, etc.), as described above, in the prior art the only action that can be taken at the DB has been to release the resource within its own node, but in the present invention, since the node information of the SSP is received as the subnode information from the SCP and stored in the DB, if a signal cannot be transmitted to the SCP, a signal can be transmitted to the SSP by using the subnode information, making it possible to release the resource at the SSP at the same time.

As described above, according to the present invention, since call control information can be transferred between the source node and the cooperating node without the intervention of a relay node, the signal transfer processing load on the relay node can be alleviated, and further, traffic in the common channel signaling network can also be reduced.

Furthermore, by making direct communications possible between the source node and the cooperating node without the intervention of a relay node, and by dynamically controlling a call in accordance with instructions from the nodes at both terminating ends or with an arbitrarily determined sequence, not only can the versatility of service call control be achieved, but because of reduced communication processing time, serviceability to end users (characterized by real time responses) can be enhanced.

Moreover, if congestion or other failure occurs at the relay node or at a common channel signaling station adjacent to it, since the resources at both the cooperating node and the source node can be released without holding the call control resources, the reaction (call release) to the communication end user can be immediately executed, offering the effect of enhancing the serviceability.

1. A communication control method in an intelligent network in which a first transaction is assigned between a first node and a second node and a second transaction between the second node and a third node in response to a service request from a subscriber, comprising the steps of:
transmitting from the second node to the third node a message containing an identifier of the first node and an identifier of the first transaction by using the second transaction; and
storing at the third node the identifier of the first node and the identifier of the first transaction transmitted from the second node, thereby making it possible to transmit a message from the third node to the first node without passing through the second node.

2. A method according to claim 1, wherein the first node is a service switching node which, in response to a request from a subscriber, requests a service control node for service processing, the second node is the service control node, and the third node is a cooperating node which accomplishes the service processing in cooperation with the service control node in response to a request from the service control node.

3. A method according to claim 1, wherein the first node is a cooperating node which accomplishes service processing in cooperation with a service control node in response to a request from the service control node, the second node is the service control node, and the third node is a service switching node which, in response to a service request from a subscriber, requests the service control node for service processing.

4. A method according to claim 3, further comprising the steps of:
transmitting from the service switching node to the cooperating node a second message containing the identifier of the service switching node and the identifier of the second transaction by using the identifier of the cooperating node and the identifier of the first transaction stored at the service switching node in the storing step;
transmitting data from the cooperating node to the service switching node in response to the second message without passing through the service control node;
transmitting from the service switching node to the cooperating node a third message containing the identifier of the service control node and the identifier of the first transaction by using the identifier of the cooperating node and the identifier of the first transaction stored at the service switching node; and
transmitting data from the cooperating node to the service switching node in response to the third message by passing through the service control node.

5. A method according to claim 2, further comprising the step of transmitting from the cooperating node to the service switching node, without passing through the service control node, a message for releasing a resource for the first transaction by using the identifier of the service switching node and the identifier of the first transaction stored at the cooperating node in the storing step, upon receiving a notification notifying that a path passing through the service control node is congested.

6. A communication control apparatus in an intelligent network in which a first transaction is assigned between a first node and a second node and a second transaction between the second node and a third node in response to a service request from a subscriber, wherein the communication control apparatus is responsible for controlling the third node, the apparatus comprising:
means for extracting an identifier of the first node and an identifier of the first transaction from a message transmitted from the second node over the second transaction; and
means for storing the identifier of the first node and the identifier of the first transaction extracted from the message, thereby making it possible to transmit a message to the first node without passing through the second node.

7. An apparatus according to claim 6, wherein the first node is a service switching node which, in response to a request from a subscriber, requests a service control node for service processing, the second node is the service control node, and the third node is a cooperating node which accomplishes the service processing in cooperation with the service control node in response to a request from the service control node.

8. An apparatus according to claim 6, wherein the first node is a cooperating node which accomplishes service processing in cooperation with a service control node in response to a request from the service control node, the second node is the service control node, and the third node is a service switching node which, in response to a service request from a subscriber, requests the service control node for service processing.

9. An apparatus according to claim 8, further comprising:
means for transmitting a second message containing the identifier of the service switching node and the identifier of the second transaction to the cooperating node by using the identifier of the cooperating node and the identifier of the first transaction stored in the storing means, and thereby permitting data to be transmitted to the cooperating node without passing through the service control node; and
means for transmitting a third message containing the identifier of the service control node and the identifier of the first transaction to the cooperating node by using the identifier of the cooperating node and the identifier of the first transaction stored in the storing means, and thereby permitting data to be transmitted to the cooperating node by passing through the service control node.

10. An apparatus according to claim 7, further comprising means for transmitting, without passing through the service control node, a message for releasing a resource for the first transaction to the service switching node by using the identifier of the service switching node and the identifier of the first transaction stored in the storing means, upon receiving a notification notifying that a path passing through the service control node is congested.
